(19) United States
(12) Patent Application Publication
(10) Pub. No.: US 2012/0323665 A1
(43) Pub. Date: Dec. 20, 2012

(54) SYSTEMS, DEVICES AND METHODS FOR COUPON VERIFICATION

(75) Inventors: Lixin Xu, Beijing (CN); Bo Wu, Santa Clara, CA (US)

(73) Assignee: LaShou Group Inc.

(21) Appl. No.: 13/327,117

(22) Filed: Dec. 15, 2011

(30) Foreign Application Priority Data
Jun. 20, 2011 (CN) 201110164102.3

(51) Int. Cl. G06Q 30/02

(52) U.S. Cl. 705/14.26

(57) ABSTRACT

Computer-implemented methods, systems and devices facilitating the methods, and computer-readable medium storing computer readable code, which, when executed, performs the methods are provided for coupon verification. The methods include receiving from a coupon verification terminal via a mobile network a verification data package based on at least an additional verification information and a verification code of a coupon, verifying whether or not the coupon is valid and has not been redeemed, and sending the verification result via the mobile network to the coupon verification terminal. The coupon verification terminal comprises an input module, a CPU configured to provide the additional verification information and to generate the verification data package by encrypting the additional verification information and the verification code, and a mobile communication module configured to, via a mobile network, send the verification data package to a verification server and receive a verification result from the verification server.

### CROSS-REFERENCE TO RELATED PATENT APPLICATIONS

China P.R. Priority Application 201110164102.3, filed Jun. 20, 2011 including the specification, drawings, claims and abstract, is incorporated herein by reference in its entirety.

### FIELD OF DISCLOSURE

The present disclosure relates generally to systems, devices and methods for verifying certificates, vouchers or coupons for goods or services, and more particularly for verifying coupons to redeem the goods and services purchased through an internet commerce platform.

### BACKGROUND

With the rapid development of internet commerce, verification of certificates, vouchers or coupons for goods or services (referred to hereafter as “coupon” or “coupons” in general) has become a critical daily work of merchants and on-line commerce platform providers.

Conventional coupon verification methods include verifications via telephone or computer. For example, merchants may provide a verification code of the coupons received from customers by calling a verification hotline, the receiver of which then transmits the information received via telephone to a verification server. The verification server verifies the code and notifies the verification result to the merchants via the hotline by playing previously recorded voice messages. Specifically, the merchant's telephone number is saved in the telephone verification system so that when the merchant calls the hotline, the server may identify the particular merchant by the phone number. Once the server verifies the merchant's identity by a valid phone number thereof, the merchant can then enter the coupon verification code via the hotline. The server may then verify the validity of the coupon by the coupon verification code. If the coupon is deemed valid by the server, the customer can then redeem the goods or services purchased online from the merchant using the valid coupon. Such a telephone verification is not efficient, as many errors may occur during the complicated process, especially when the merchant has to operate in a noisy environment.

Another conventional method involves computer verification terminal that is connected to the internet. The merchant can use a pre-installed software or use an internet browser to communicate with the verification server via internet. The merchant enter to the internet browser the coupon verification code, which is then verified by the verification server. The result can then be displayed on the merchant's computer. Specifically, the merchant firstly logs in to a website, where the merchant can access to an interface to enter coupon verification codes and submit requests for verifying the validity of the coupon codes by the server. Such a computer verification method requires at least a computer and internet access, and is thus not applicable in a variety of outdoor and/or non-fixed location scenarios.

In view of the above-explained problems of the conventional coupon verification methods, the instant application is directed to improve the coupon verification technology.

### SUMMARY

According to one embodiment, a coupon verification method is provided including receiving from a coupon verification terminal via a mobile network a verification data package based on at least an additional verification information and a verification code of a coupon, verifying whether or not the coupon is valid and has not been redeemed, wherein a positive verification result is returned if the coupon is valid and has not yet been redeemed, and a negative verification result is returned if the coupon is either invalid or has previously been redeemed, and sending the verification result via the mobile network to the coupon verification terminal.

According to another embodiment, a coupon verification system is provided including a receiving unit configured to receive from a coupon verification terminal via a mobile network a verification data package based on at least an additional verification information and a verification code of a coupon, a verification unit configured to verify whether or not the coupon is valid and has not been redeemed, wherein a positive verification result is returned if the coupon is valid and has not yet been redeemed, and a negative verification result is returned if the coupon is either invalid or has previously been redeemed, and a result sending unit configured to send the verification result via the mobile network to the coupon verification terminal.

According to another embodiment, a coupon verification terminal is provided including an input module configured to input a verification code of a coupon, a CPU configured to provide additional verification information and to generate a verification data package by encrypting the additional verification information and the verification code, and a mobile communication module configured to, via a mobile network, send the verification data package to a verification server and to receive a verification result from the verification server.

According to another embodiment, a coupon verification method is provided including entering a verification code of a coupon to a coupon verification terminal, generating a verification data package based on at least an additional verification information and the verification code of the coupon, sending the verification data package to a verification server via a mobile network, receiving a verification result from the verification server, wherein the verification result is positive if the coupon is valid and has not yet been redeemed, and negative if the coupon is either invalid or has already been redeemed.

According to another embodiment, a non-transitory computer-readable medium is provided including storing computer readable code, which, when executed, performs the method described above.

These and other embodiments and advantages thereof will become more readily apparent from the attached drawings and the detailed description that follow.

### BRIEF DESCRIPTION OF THE DRAWINGS

The preferred embodiments of the invention will be described in conjunction with the appended drawings provided to illustrate and not to the limit the invention, where like designations denote like elements, and in which:

FIG. 1 illustrates an exemplary system according to one embodiment of the present invention.

FIG. 2 illustrates an exemplary coupon verification terminal according to one embodiment of the present invention.

FIG. 3 illustrates a schematic drawing of a coupon verification terminal in a first non-limiting example.

FIG. 4 illustrates a flow chart according to a first non-limiting example of the present invention.

FIG. 5 illustrates a flow chart according to a second non-limiting example of the present invention.

### DETAILED DESCRIPTION

Following below are more detailed descriptions of various concepts related to, and embodiments of the above-described methods, systems and non-transitory computer-readable medium for implementing the methods. It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes.

According to one embodiment, a coupon verification method is provided including receiving from a coupon verification terminal via a mobile network a verification data package based on at least an additional verification information and a verification code of a coupon, verifying whether or not the coupon is valid and has not been redeemed, wherein a positive verification result is returned if the coupon is valid and has not yet been redeemed, and a negative verification result is returned if the coupon is either invalid or has previously been redeemed, and sending the verification result via the mobile network to the coupon verification terminal. In some embodiments, the verification code of a coupon is issued by an internet commerce platform, for example but not limited to an internet group buying platform. If a negative verification result is returned because the coupon has been redeemed, the coupon verification terminal may display when and/or where the coupon was redeemed.

In some embodiments, the coupon verification method further comprises registering the coupon as been redeemed after a positive verification result is returned. In some other embodiments, the coupon verification method further comprises sending an inquiry to the coupon verification terminal as to whether the coupon is to be redeemed, receiving a consumption request data package from the verification terminal, wherein the consumption request data package comprises a coupon consumption serial number generated by the coupon verification terminal, the coupon information, and verification terminal ID, comparing the consumption request data package with a database to determine whether or not the coupon is valid has not been redeemed, sending a positive result to the coupon verification terminal and registering the coupon as redeemed under the coupon consumption serial number if the coupon is found valid and has not been redeemed, sending a positive result to the coupon verification terminal if the coupon is found valid but has been redeemed with a same coupon consumption serial number, and sending a negative result to the coupon verification terminal if the coupon is found invalid or if the coupon has been redeemed with a different coupon consumption serial number. If the coupon verification terminal confirms not to redeem the coupon at this point of time the verification process is terminated.

In some embodiments, the coupon verification terminal may be configured to print and/or display the verification result.

The verification data package may be produced by the coupon verification terminal by encrypting the additional verification information and the verification code of the coupon followed by transcoding. The additional verification information may comprise any suitable information, for example but not limited to at least one of current time of the coupon verification terminal, a terminal ID of the coupon verification terminal, a merchant ID number of a corresponding merchant, a serial number generated by the coupon verification terminal, a total number of coupons verified by the coupon verification terminal.

In some embodiments, the verification data package is further url coded. Any suitable encryption and transcoding methods may be used, for example in some embodiments, the encryption is aes128 encryption, and the transcoding is a base 64 transcoding.

Any suitable mobile network may be used. In some embodiments, the mobile network is selected from at least one of GPRS network, WCDMA network, TD-SCDMA network or CDMA2000 network.

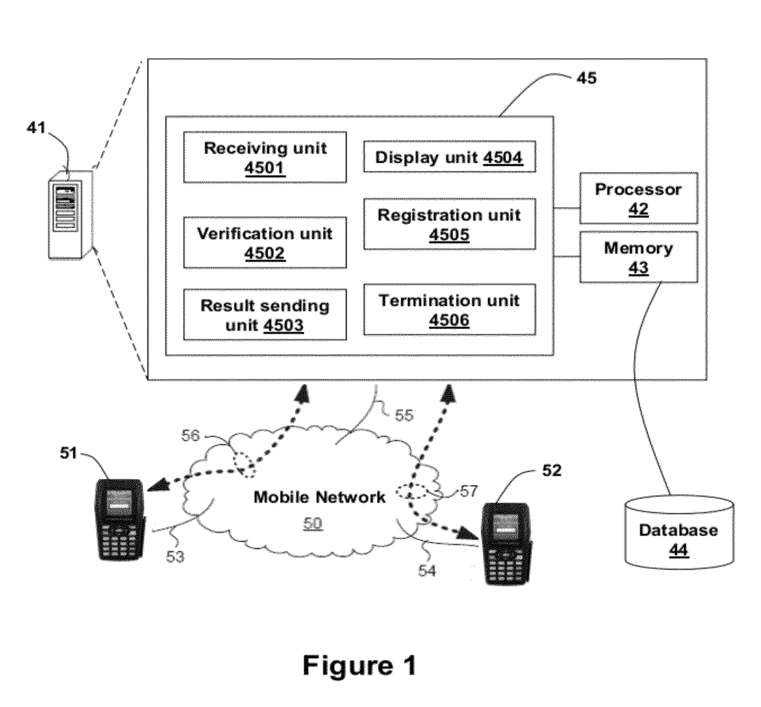

FIG. 1 illustrates an example system for implementing embodiments detailed below. As illustrated in FIG. 1, a system according to one embodiment of the present invention may comprise a server 41, a plurality of coupon verification terminals such as a first coupon verification terminal 51, a second coupon verification terminal 52, and a mobile network 50 that interconnects the server 41 and the plurality of coupon verification terminals via wired or wireless communication links 53-55. The system may be used at the merchant sites to verify coupon issued to consumers of goods and/or service via an internet commerce platform, for example but not limited to a group buying website. For example, the merchants may utilize coupon verification terminals to communicate with the server 41 for verifying coupon codes provided by the consumers to determine whether or not the consumer may redeem the coupon he posses for corresponding goods and/or services. Any desired devices, such as cell phone, PDA, computer and other electronic devices that is capable of processing the coupon verification data and allow transmission of the coupon verification and related data to and from the server 41 via a mobile network may be used as the coupon verification terminals. Any suitable mobile network, for example but not limited to GPRS network, WCDMA network, TD-SCDMA network or CDMA2000 network, may be used.

The server 41 comprises a processor 42, a memory device 43 that connects to a permanent database 44, and a coupon verification management module 45. The coupon verification management module 45 comprises a receiving unit 4501, a verification unit 4502, a result sending unit 4503, a display unit 4504, a registration unit 4505, and a termination unit 4506.

The receiving unit 4501 is configured to receive from a coupon verification terminal via a mobile network a verification data package based on at least an additional verification information and a verification code of a coupon.

The verification data package may be produced by encrypting the additional verification information and the verification code of the coupon followed by transcoding. In some embodiments, the verification data package is further url coded. Any suitable encryption and transcoding methods may be used, for example in some embodiments, the encryption is aes128 encryption, and the transcoding is a base 64 transcoding. The additional verification information may comprise any suitable information, for example but not limited to at least one of current time of the coupon verification terminal, a terminal ID of the coupon verification terminal, a merchant ID number of a corresponding merchant, a serial number generated by the coupon verification terminal, a total number of coupons verified by the coupon verification terminal.

The verification unit 4502 is configured to verify whether or not the coupon is valid and has not been redeemed, wherein a positive verification result is returned if the coupon is valid and has not yet been redeemed, and a negative verification result is returned if the coupon is either invalid or has previously been redeemed. In some embodiments, the verification unit 4502 may comprise a decoding unit, which is configured to decode the verification data package received from the coupon verification terminal, prior to compare the coupon information received from the coupon verification terminal with a valid coupon database.

The result sending unit 4503 can then send the verification result via the mobile network to the coupon verification terminal. The display unit 4504 is configured to cause the coupon verification terminal to display when and/or where the coupon was redeemed if the coupon has been previously redeemed.

In some embodiments, the registration unit 4505 is an automatic registration unit configured to register the coupon as been redeemed after a positive verification result is returned. Alternatively, the registration unit 4505 may be an active registration unit configured to send an inquiry to the coupon verification terminal as to whether the coupon is to be redeemed, receive a consumption request data package from the verification terminal, wherein the consumption request data package comprises a coupon consumption serial number generated by the coupon verification terminal, the coupon information, and verification terminal ID, compare the consumption request data package with a database to determine whether or not the coupon is valid has not been redeemed, send a positive result to the coupon verification terminal and register the coupon as redeemed under the coupon consumption serial number if the coupon is found valid and has not been redeemed, send a positive result to the coupon verification terminal if the coupon is found valid but has been redeemed with a same coupon consumption serial number, and send a negative result to the coupon verification terminal if the coupon is found invalid or if the coupon has been redeemed with a different coupon consumption serial number.

The termination unit 4506 is configured to terminate the verification process if the coupon verification terminal confirms not to redeem the coupon.

The different modules within the coupon verification management module 45 are function modules that interwork with each other. The function modules, when executed by processor 42, allow the system to effectively and efficiently manage the above-described coupon verification processes. One or more of the function modules may be omitted, and additional modules may be added if needed. Communication messages (e.g., 56 and 57) may be exchanged between the server 41 and coupon verification terminals 51-52, etc., via the mobile network 50.

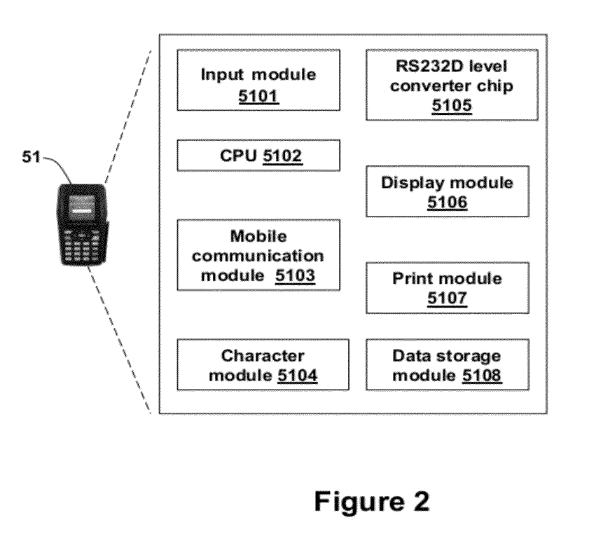

In some embodiments, as illustrated in FIG. 2, the coupon verification terminal 51 may include at least an input module 5101 configured to input a verification code of a coupon, a CPU 5102, and a mobile communication module 5103. In some embodiments, the coupon verification terminal 51 may further comprise character module 5104, an RS232D level converter chip 5105, an display module 5106 configured to display the verification result, a print module 5107 configured to cause a printer to print the verification result, and a data storage module 5108 configured to store a historical record of verification process performed by the coupon verification terminal. In some embodiments, the CPU 5102, character module 5104, RS232D level converter 5105 chip, and data storage module 5108 may be located on a mother board (not shown).

The CPU 5102 is configured to provide additional verification information and to generate a verification data package by encrypting the additional verification information and the verification code. The additional verification information may comprise any suitable information, for example but not limited to at least one of current time of the coupon verification terminal, a terminal ID of the coupon verification terminal, a merchant ID number of a corresponding merchant, a serial number generated by the coupon verification terminal, a total number of coupons verified by the coupon verification terminal. The mobile communication module 5103 configured to, via a mobile network, send the verification data package to the verification server 41 and to receive a verification result from the verification server 41.

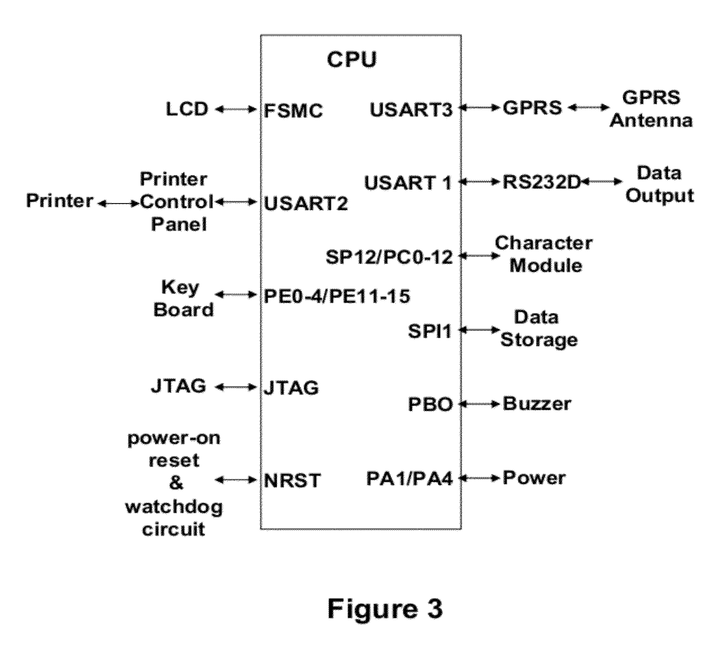

FIG. 3 shows a schematic drawing of a coupon verification terminal in a first non-limiting example. In this non-limiting example, the coupon verification terminal comprises a mother board, on which a CPU and its external circuit, a data storage module, and a character module. The mother board may also comprise ports for connecting the CPU to a display module, a print module, a mobile communication module, a data export, a SIM card, a battery, an input module, a joint test action group (JTAG), and a buzzer. In this non-limiting example, GPRS module is used for the mobile communication. Of course, any other suitable mobile networks, such as WCDMA network, TD-SCDMA network or CDMA 2000 network, may be used.

In this non-limiting example, the CPU is a STM32F103VCT6 having a core of ARM 32-bit Cortex™ M3, which has an up to 72 MHz frequency and has a built-in 256K flash memory and 48 k SRAM. The STM32F103VCT6 chip can have a built-in power-on reset and watchdog circuit. In this example, the chip reserves an external power-on reset and watchdog circuit, where a IMP706TESA chip may be used. For using the built-in circuit, a 0.01 μF capacitor needs to be connected to the NRST pin of the CPU to shield the external reset chip.

The CPU has a FSMC module that can be connected to a LCD display, and a real-time clock circuit that can be connected to a crystal and a battery or other power supply. It also has 5 USAPT ports, one of which can be used for burning programs and upgrades. In addition, the 2 SPI ports can be used for connecting the storage devices with the CPU.

The terminal may also has a multi-channel AD control circuit that can be used for analog data acquisition and monitoring, a multiple GPIO, and a variety of power-saving mode.

In this non-limiting example, the terminal is supplied by a 12V/1.5A power adapter, using a 7.4V rechargeable lithium-ion battery pack as a backup power source when there is no electricity available. The power supply can be seamlessly switched to battery simply by removing the power adapter. When operating on battery power, the user can optionally choose whether or not to use a power saving mode to extend the battery run time. The power adapter can function correctly regardless whether the battery is assembled in the terminal or not.

In some embodiments, the terminal may have a hard power switch. Alternatively, the terminal may have no hard power switch, while a soft power switch may be included on a keyboard of the input module. When it is turned off, the CPU will turn off all peripheral power supply, and enter a sleep mode. In the sleep mode, only the CPU itself consumes power, lowering the current to about 10 mA or smaller.

The data storage module used in this example is W25Q16 having an SPI interface and a storage capacity of 2M bytes. The storage capacity can be changed to smaller or greater if desired.

In this non-limiting example, a GT23L24T3Y module having a SPI port is used for the character module. The GT23L24T3Y module has three sets of fonts including GB2312, GB12345 and BIG5, as well as three built-in matrix including a 11×12 matrix, a 15×16 matrix and a 24×24 matrix.

The UART port of the RS232 level converter chip can be used as the data export port, connecting to the USART port of the CPU. This UART port can also be used of burning programs to the CPU. When burning programs via the USART1 port, Boot 1 and Boot 0 shall be set to 01, while in operating mode Boot 1 and Boot 0 are set to 00.

In this example, a surface mount passive buzzer is used as the buzzer interface circuit, to provide a buzzer small enough to fit the small space limited by the size of terminal.

A printer control panel is included in this example as a relatively independent unit, which has a separate CPU, character module and a printer driver module. In this example, a STM32F101RBT6 CPU having a frequency up to 36 MHz, with a 10K bytes built-in RAM, 64K byte Flash memory, is used for the printer control panel CPU. The printer control panel can communicate with the CPU on the mother board of the terminal. The character module of the printer control panel may be the same as that of the mother board. The programs can be burned via the JTAG port.

Specifically, a verification code of a coupon may be entered to an above-described coupon verification terminal, which will then generate a verification data package based on at least an additional verification information and the verification code of the coupon, send the verification data package to a verification server via a mobile network, and receive a verification result from the verification server. The coupon verification terminal may generate the verification data package by aes128 encrypting the additional verification information and the verification code, followed by base 64 transcoding and url coding. The additional verification information comprises at least one of current time of the coupon verification terminal, a terminal ID of the coupon verification terminal, a merchant ID number of a corresponding merchant, a serial number generated by the coupon verification terminal, a total number of coupons verified by the coupon verification terminal. In some embodiments, the coupon verification terminal will display a positive verification result if the coupon is valid and has not yet been redeemed, and show a negative verification result if the coupon code entered is either invalid or has already been redeemed previously.

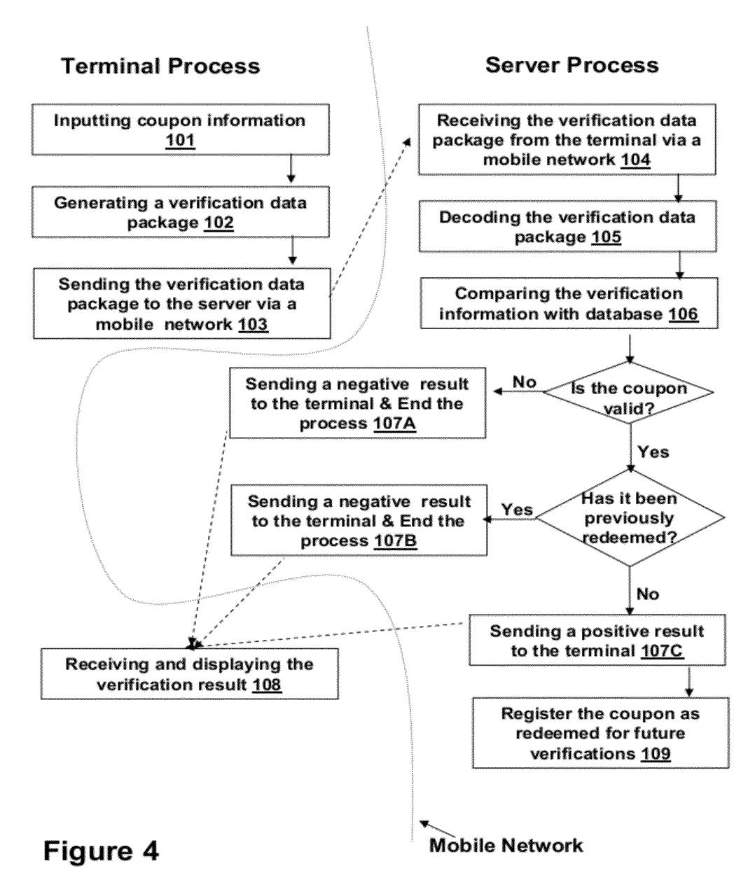

FIG. 4 illustrates a flow chart according to a non-limiting example of how a merchant can use the coupon verification terminal to communicate with the verification server and how the methods described above may be facilitated. In this example, a group buying website is used as an illustrative example. Other internet commerce sites may also use similar methods that allow participating merchants to verify coupon issued by the internet commerce sites.

First, the information of a participating merchant, for example but not limited to name, phone number, address, etc., can be recorded to the verification server, which then issue a merchant ID that identifies a specific merchant. Each verification terminal has a unique verification terminal ID. A merchant may use one or more verification terminals, but a verification terminal can only be bound to one particular merchant. The corresponding information of the merchant ID and the verification terminal IDs are recorded to the verification server.

The merchant can input the coupon information, for example but not limited to a coupon serial number and a password of the coupon, etc., to the coupon verification terminal, at step 101. Such coupon information will then be processed by the CPU of the coupon verification terminal to encrypt with the current time by aes 128 encryption. The encrypted data can then be base 64 transcoded with the verification terminal ID, followed by a url transcoding to generate a verification data package, at step 102. The verification data package can then be communicated to the verification server using HTTP protocol GET method via a mobile network, for example but not limited to GPRS network, WCDMA network, TD-SCDMA network or CDMA2000 network, at step 103.

After receiving the verification data package, at step 104, from the coupon verification terminal, the verification server will perform url decoding, following by base 64 decoding, at step 105. The server can identify the particular merchant by comparing the verification terminal ID with the database saved. If a corresponding merchant ID is not identified, such information will be sent the coupon verification terminal. If a corresponding merchant ID is identified, the verification data package will be further decoded to obtain the password of the coupon, at step 105. The merchant ID and the coupon password can then be used to verify whether the coupon is valid, and whether the specific coupon has been redeemed or not, at step 106. The verification result will be sent to the coupon verification terminal, at step 107, which will then be received and displayed by the coupon verification terminal to the merchant, at step 108.

If the coupon is found invalid, of course, a negative result will be returned, at step 107A. If the coupon is found valid, but has been previously redeemed, a negative result will be returned, at step 107B. Further, if the coupon is found valid, and has not been previous redeemed, a positive result will be returned at step 107C.

The verification results may be displayed by an LCD display module of the verification terminal to the merchant and/or the customer. Negative verification results may provide to the merchant/customer extra information, for example causing a display showing that: (1) the coupon is invalid, cannot be used to redeem the goods/services; (2) the coupon expired and when; (3) the coupon has been previously redeemed and when; (4) the coupon can not be used for other reasons and why (e.g., the coupon is suspended or a request for refund is pending, etc.). Similarly, a positive verification result may provide extra information such as name of the goods/services purchased and price, etc.

The system will then ask whether the coupon is to be redeemed. Once the customer confirms that he or she would like to redeem the coupon now, such confirmation may be entered to the coupon verification terminal. In this non-limiting example, the server will then register the coupon as redeemed for future verifications, at step 109.

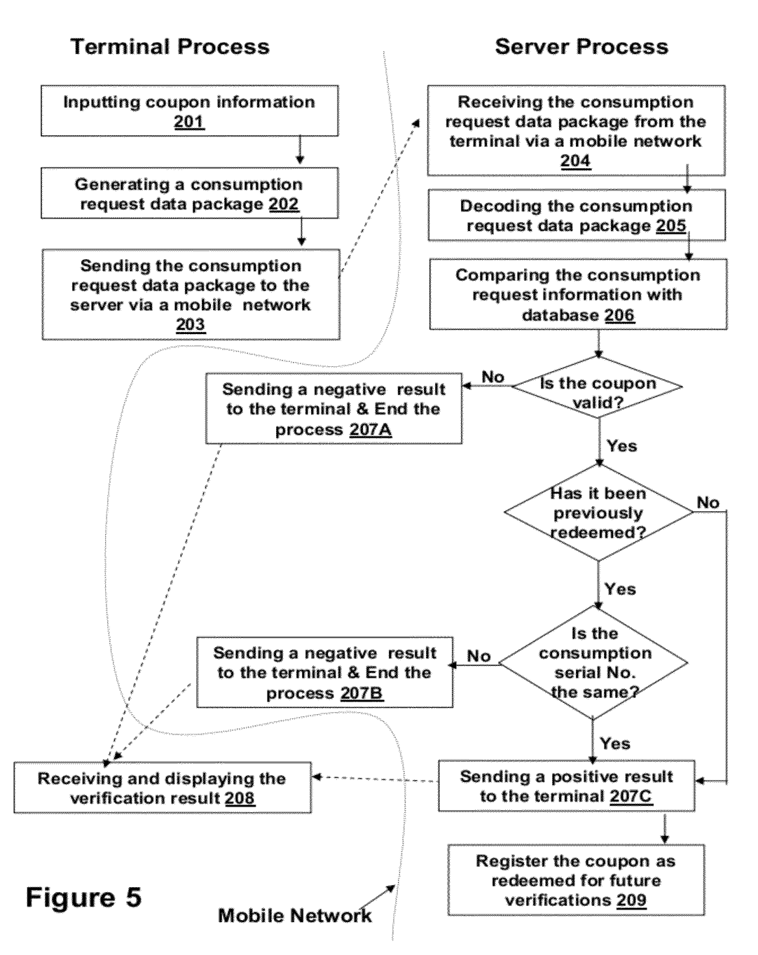

Alternatively, the system may comprise an extra confirmation step to reduce false negative verifications that may be resulted from the terminal re-sending a same request to the server when a positive verification result is lost in the communication and therefore not received at the terminal. FIG. 5 illustrates a flow chart according to a non-limiting example according to this alternative embodiment.

First, after the coupon information is entered to the terminal, at step 201, the CPU of the coupon verification terminal may generate a unique serial number to identify the consumption of the coupon. Such a coupon consumption serial number, can be aes 128 transcoded with the coupon password, the current time of the coupon verification terminal, and the total number of coupon redeemed according to the coupon verification terminal data storage. The encrypted information and the verification terminal ID can then be base 64 transcoded, followed by url transcoding to generate the consumption request data package, at step 202.

The consumption request data package can then be communicated to the verification server by HTTP protocol GET method via a mobile network, for example but not limited to GPRS network, WCDMA network, TD-SCDMA network or CDMA2000 network, at step 203. After receiving the consumption request data package, at step 204, from the coupon verification terminal, the verification server will perform url decoding, following by base 64 decoding. The server can identify the particular merchant by comparing the verification terminal ID with the database saved. If a corresponding merchant ID is not identified, such information will be sent the coupon verification terminal. If a corresponding merchant ID is identified, the consumption request data package will be further decoded to obtain the password of the coupon, at step 205. The merchant ID and the coupon password can then be used to verify whether the coupon is valid, and whether the specific coupon has been redeemed or not, at step 206. The verification result will be sent to the coupon verification terminal, at step 207, which will then be received and displayed by the verification terminal, at step 208, to the merchant and/or customer.

If the coupon is found valid, and has not been previously redeemed, a positive verification result will be returned, at step 207C. When the verification result shows that the coupon has been previously redeemed, rather than simply returning a negative result as step 107B of the previous example, the verification server will further compare the coupon consumption serial number and the coupon number received from the verification terminal with the database. In this case, if an identical record is found in the database, then the server would treat this present request as a request redundant to a previous request, a verification result of which has not been successfully communicated back to the coupon verification terminal. In other words, in absence of receiving such a verification result, the verification terminal may be re-sending the request accordingly. In this situation, the sever will send a positive verification result showing that the coupon is valid and can be redeemed, at step 207C.

Alternatively, if an identical record is not found, the server will then send a verification result to the terminal showing that the coupon has been previously redeemed and can not be used again, at step 207B.

If the coupon is found invalid, of course, a negative result will be returned, at step 207A.

The verification results may be displayed by an LCD display module of the verification terminal to the merchant and/or the customer, and/or printed if desired. Negative verification results may provide to the merchant/customer extra information, for example causing a display showing that: (1) the coupon is invalid, cannot be used to redeem the goods/services; (2) the coupon expired and when; (3) the coupon has been previously redeemed and when; (4) the coupon can not be used for other reasons and why (e.g., the coupon is suspended or a request for refund is pending, etc.). Similarly, a positive verification result may provide extra information such as name of the goods/services purchased and price, etc.

If the verification result is positive, the verification server will then register this particular coupon as redeemed, at step 209, and save the time of consumption, and send a consumption registration confirmation to the verification terminal.

The coupon verification terminal will save the verification history in the data storage module of the terminal. In this non-limiting example, the data storage module can save up to 15000 records. When the total number of records is above 13000, the coupon verification terminal will send a message to the verification server and/or the owner of the internet commerce website that the verification terminal needs to be changed/renewed.

Compared to the conventional telephone or computer verification methods, the above-described methods have many advantages. For example, using the verification terminal and the system described above, the verification process of a coupon can be less than 3 seconds, which is almost impossible if the conventional methods are used. Second, the verification process is much more reliable. The terminal can save records of the verification history, providing another source of data for possible auditing if desired. In contrast, if the conventional methods are used, the verification history is only available at the server. Third, it is more convenient for the merchant to use, without requiring the complicated voice direction and password entering in the telephone verification or computer and internet knowledge in using the computer verification method. Finally, the above described method does not require an internet access, because mobile network is used for communication instead, and therefore can be used in remote area conveniently.

The functions and modules described above may be implemented in hardware, software, firmware, or any combinations thereof. If implemented in software, the functions may be stored on or transmitted over as one or more instructions or code on a computer readable (processor-readable) medium. Computer-readable media include both computer storage media and communication media including any medium that facilitates transfer of a computer program from one place to another. A storage media may be any available media that can be accessed by a computer or similar devices. By way of example, and not limitation, such computer-readable media can comprise RAM, ROM, EEPROM, CDROM or other optical disk storage, magnetic disk storage or other magnetic storage devices, or any other medium that both can be used to carry or store desired program code in the form of instructions or data structures, and can be accessed by a computer or similar devices. In addition, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies are included in the definition of medium. Disk and disc, as used herein, include compact disc (CD), laser disc, optical disc, digital versatile disc (DVD), floppy disk, and blue-ray disc where disks usually reproduce data magnetically, while discs reproduce data optically with lasers. Combinations of the above should also be included within the scope of computer-readable media.

The above-described embodiments and examples are to be considered in all respects only as illustrative and not restrictive, and the scope of the invention is, therefore, indicated by the appended claims rather than by the foregoing description. Those of skill in the art will recognize changes, substitutions and other modifications that will nonetheless come within the scope of the invention and range of the claims.

What is claimed is:

1. A coupon verification method, comprising:
receiving from a coupon verification terminal via a mobile network a verification data package based on at least an additional verification information and a verification code of a coupon;
verifying whether or not the coupon is valid and has not been redeemed, wherein a positive verification result is returned if the coupon is valid and has not yet been redeemed, and a negative verification result is returned if the coupon is either invalid or has previously been redeemed; and
sending the verification result via the mobile network to the coupon verification terminal.

2. The coupon verification method of claim 1, further comprising causing the coupon verification terminal to display when and/or where the coupon was redeemed if the coupon has been previously redeemed.

3. The coupon verification method of claim 1, further comprising registering the coupon as been redeemed after a positive verification result is returned.

4. The coupon verification method of claim 1, further comprising:
sending an inquiry to the coupon verification terminal as to whether the coupon is to be redeemed;
receiving a consumption request data package from the verification terminal, wherein the consumption request data package comprises a coupon consumption serial number generated by the coupon verification terminal, the coupon information, and verification terminal ID;
comparing the consumption request data package with a database to determine whether or not the coupon is valid has not been redeemed;
sending a positive result to the coupon verification terminal and registering the coupon as redeemed under the coupon consumption serial number, if the coupon is found valid and has not been redeemed;
sending a positive result to the coupon verification terminal if the coupon is found valid but has been redeemed with a same coupon consumption serial number; and
sending a negative result to the coupon verification terminal if the coupon is found invalid or if the coupon has been redeemed with a different coupon consumption serial number.

5. The coupon verification method of claim 1, further comprising terminating the verification process if the coupon verification terminal confirms not to redeem the coupon.

6. The coupon verification method of claim 1, wherein the verification code of a coupon is issued by an internet commerce platform.

7. The coupon verification method of claim 1, wherein the coupon verification terminal is configured to print and/or display the verification result.

8. The coupon verification method of claim 1, wherein the verification data package is generated by the coupon verification terminal by encrypting the additional verification information and the verification code of the coupon followed by transcoding.

9. The coupon verification method of claim 8, wherein the verification data package is further url coded.

10. The coupon verification method of claim 8, wherein the encryption is aes128 encryption, and the transcoding is a base 64 transcoding.

11. The coupon verification method of claim 1, wherein the mobile network is selected from at least one of GPRS network, WCDMA network, TD-SCDMA network or CDMA2000 network.

12. The coupon verification method of claim 1, wherein the additional verification information comprises at least one of current time of the coupon verification terminal, a terminal ID of the coupon verification terminal, a merchant ID number of a corresponding merchant, a serial number generated by the coupon verification terminal, a total number of coupons verified by the coupon verification terminal.

13. A coupon verification system, comprising:
a receiving unit, executed with one or more computer processors, configured to receive from a coupon verification terminal via a mobile network a verification data package based on at least an additional verification information and a verification code of a coupon;
a verification unit, executed with said one or more computer processors, configured to verify whether or not the coupon is valid and has not been redeemed, wherein a positive verification result is returned if the coupon is valid and has not yet been redeemed, and a negative verification result is returned if the coupon is either invalid or has previously been redeemed; and
a result sending unit, executed with said one or more computer processors, configured to send the verification result via the mobile network to the coupon verification terminal.

14. The coupon verification system of claim 13, further comprising a display unit configured to cause the coupon verification terminal to display when and/or where the coupon was redeemed if the coupon has been previously redeemed.

15. The coupon verification system of claim 13, further comprising an automatic registration unit configured to register the coupon as been redeemed after a positive verification result is returned.

16. The coupon verification system of claim 13, further comprising an active registration unit configured to:
send an inquiry to the coupon verification terminal as to whether the coupon is to be redeemed;
receive a consumption request data package from the verification terminal, wherein the consumption request data package comprises a coupon consumption serial number generated by the coupon verification terminal, the coupon information, and verification terminal ID;
compare the consumption request data package with a database to determine whether or not the coupon is valid has not been redeemed;
send a positive result to the coupon verification terminal and registering the coupon as redeemed under the coupon consumption serial number, if the coupon is found valid and has not been redeemed;
send a positive result to the coupon verification terminal if the coupon is found valid but has been redeemed with a same coupon consumption serial number; and
send a negative result to the coupon verification terminal if the coupon is found invalid or if the coupon has been redeemed with a different coupon consumption serial number.

17. The coupon verification system of claim 13, further comprising a termination unit configured to terminate the verification process if the coupon verification terminal confirms not to redeem the coupon.

18. The coupon verification system of claim 13, wherein the verification code of a coupon is issued by an internet commerce platform.

19. The coupon verification system of claim 13, wherein the verification data package is produced by the coupon verification terminal by encrypting the additional verification information and the verification code of the coupon followed by transcoding.

20. The coupon verification system of claim 19, wherein the verification data package is further url coded.

21. The coupon verification system of claim 19, wherein the encryption is aes128 encryption, and the transcoding is a base 64 transcoding.

22. The coupon verification system of claim 13, wherein the mobile network is selected from at least one of GPRS network, WCDMA network, TD-SCDMA network or CDMA2000 network.

23. The coupon verification system of claim 13, wherein the additional verification information comprises at least one of current time of the coupon verification terminal, a terminal ID of the coupon verification terminal, a merchant ID number of a corresponding merchant, a serial number generated by the coupon verification terminal, a total number of coupons verified by the coupon verification terminal.

24. The coupon verification system of claim 13, further comprising the coupon verification terminal, wherein the coupon verification terminal comprising:
an input module configured to input the verification code of the coupon;
a CPU configured to provide the additional verification information and to generate the verification data package by encrypting the additional verification information and the verification code; and
a mobile communication module configured to, via the mobile network, send the verification data package to a verification server and to receive a verification result from the verification server, wherein the mobile network is selected from at least one of GPRS network, WCDMA network, TD-SCDMA network or CDMA2000 network.

25. A coupon verification terminal, comprising:
an input module configured to input a verification code of a coupon;
a CPU configured to provide additional verification information and to generate a verification data package by encrypting the additional verification information and the verification code; and
a mobile communication module configured to, via a mobile network, send the verification data package to a verification server and to receive a verification result from the verification server.

26. The coupon verification terminal of claim 25, further comprising:
a display module configured to display the verification result; and
a data storage module configured to store a historical record of verification process performed by the coupon verification terminal.

27. The coupon verification terminal of claim 25, wherein the verification data package is generated by aes128 encrypting the additional verification information and the verification code, followed by base 64 transcoding and url coding.

28. The coupon verification terminal of claim 25, further comprising a print module configured to cause a printer to print the verification result.

29. The coupon verification terminal of claim 25, further comprising character module and RS232D level converter chip.

30. The coupon verification terminal of claim 25, wherein the mobile network is selected from at least one of GPRS network, WCDMA network, TD-SCDMA network or CDMA2000 network.

31. The coupon verification terminal of claim 25, wherein the additional verification information comprises at least one of current time of the coupon verification terminal, a terminal ID of the coupon verification terminal, a merchant ID number of a corresponding merchant, a serial number generated by the coupon verification terminal, a total number of coupons verified by the coupon verification terminal.

32. A coupon verification method, comprising:
entering a verification code of a coupon to a coupon verification terminal,
generating a verification data package based on at least an additional verification information and the verification code of the coupon,
sending the verification data package to a verification server via a mobile network,
receiving a verification result from the verification server, wherein the verification result is positive if the coupon is valid and has not yet been redeemed, and negative if the coupon is either invalid or has previously been redeemed.
